(19) United States
(12) Patent Application Publication
(10) Pub. No.: US 2011/0191527 A1
(43) Pub. Date: Aug. 4, 2011

(54) SEMICONDUCTOR STORAGE DEVICE AND CONTROL METHOD THEREOF

(75) Inventor: Tohru Fukuda, Nishitokyo-shi (JP)

(73) Assignee: KABUSHIKI KAISHA TOSHIBA, Tokyo (JP)

(21) Appl. No.: 13/013,667

(22) Filed: Jan. 25, 2011

(30) Foreign Application Priority Data
Jan. 29, 2010 (JP) 2010-019546

(51) Int. Cl. G06F 12/02

(52) U.S. Cl. 711/103; 711/E12.008

(57) ABSTRACT

According to one embodiment, a semiconductor storage device comprises processors, a nonvolatile memory with channels, a list storage, and a command generator. The list storage is configured to store an erase address list includes erase addresses of each of the channels of the nonvolatile memory. The command generator is configured to continuously generate a series of erase commands concerning the erase addresses in the erase address list in response to a single erase request generated from any one of the processors.

### CROSS-REFERENCE TO RELATED APPLICATIONS

This application is based upon and claims the benefit of priority from Japanese Patent Application No. 2010-019546, filed Jan. 29, 2010; the entire contents of which are incorporated herein by reference.

### FIELD

Embodiments described herein relate generally to a semiconductor storage device including a nonvolatile memory and a control method of the semiconductor storage device.

### BACKGROUND

A memory device including multiple banks capable of carrying out a parallel write operation or parallel erase operation by using plural memory banks is disclosed in Jpn. Pat. Appln. KOKAI Publication No. 2003-36681 (paragraphs [0005], [0022] to [0023], and [0054]) as an example of a nonvolatile storage device. In general, in a nonvolatile memory, for example, a flash memory, when data is written, overwriting cannot be carried out. Therefore, it is necessary to execute an erase operation before executing a data write operation.

This memory device includes plural memory banks each of which includes a nonvolatile memory cell, and can independently carry out a memory operation, and a controller configured to control a memory operation of the memory banks. The controller is capable of controlling an interleave operation and a parallel operation. In the interleave operation, even in a memory operation of responding to an operation instruction designating a memory bank, a memory operation can be started in response to an operation instruction designating another memory bank. In the parallel operation, when immediately before start of a memory operation of responding to an operation instruction designating a memory bank, a memory operation instruction designating another memory bank is issued, the memory operations of both the memory banks can be started in parallel. As a result of this, in a flash memory of the multi-bank form including plural memory banks, it is possible to carry out erase operations or write operations at the plurality of memory banks, and shorten a period of a busy state resulting from the erase operation or write operation.

A sector erase command for instructing sector erase of one memory bank, a command code “BOH” instructing to start an erase operation is added to a tail end of an erase object sector address SA1 or SA2. In order to instruct two memory banks, in parallel, to carry out sector erase, second sector address information SAI1 and SAI2 are arranged subsequently to first sector address information SA1 and SA2, and a command code “BOH” is added to the end part. It is necessary that a memory bank designated by the second sector address information SAI1 and SAI2 should be different from a memory bank designated by the first sector address information SA1 and SA2.

In the timing chart of a two-memory bank parallel erase operation shown in FIG. 8 of Jpn. Pat. Appln. KOKAI Publication No. 2003-36681, first sector address information SA(1) and SA(2), and second sector address information SA(3) and SA(4) are successively input subsequently to a command code “20H”, and a command code “BOH” is finally input. A command decoder detects input of the command code “20H”, thereafter recognizes a memory bank designated by memory bank designation information Am included in the sector address SA(1) and SA(2), and supplies the sector address SA(1) and SA(2) to the recognized memory bank. Next, the command decoder recognizes a memory bank designated by memory bank designation information Am included in the subsequent sector address SA(3) and SA(4), and supplies the sector address SA(3) and SA(4) to the memory bank. When the memory banks designated by both the sector addresses are different from each other, a CPU is caused to carry out erase operations of sectors designated by the sector addresses in parallel on condition that the command code “BOH” is input. The CPU 21 executes an erase operation program stored by a ROM to carry out the erase operation (auto erase).

As described above, the memory device described in Jpn. Pat. Appln. KOKAI Publication No. 2003-36681 can carry out ease operations or write operations in parallel at plural memory banks in the flash memory of the multi-bank form including plural memory banks.

In the device described in Jpn. Pat. Appln. KOKAI Publication No. 2003-36681, it is assumed that the CPU issuing an erase request or write request is a single one. In recent years, the degree of integration of a memory is increased, and capacity thereof is also increased. Therefore, there is a demand for utilizing a semiconductor storage device as a storage device for a server. In a storage device for a server, plural CPUs are connected to a large number of flash memories of the multi-bank form. It should be noted that although the plurality of CPUs are provided, only any one of the CPUs takes charge of memory management. In order to execute erase operations of the banks in parallel, the CPU in charge of the memory management generates a series of erase commands. In order to secure efficiency of executing the erase operations in parallel, it is desirable that the series of erase commands be successively captured in a command queue. However, a command issued from a CPU other than the CPU in charge of the memory management is captured in the command queue by an interrupt in some cases.

When there is an interrupt of another command, in order to secure the efficiency of executing the erase operations in parallel, it is necessary to arbitrate the semaphore in consideration of exclusive control between the plurality of CPUs or to fetch an erase command over the head of the interrupt command by changing the order when a command is fetched from a command queue, and there is the problem that the control becomes complicated, and cost is increased.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary block diagram of a semiconductor storage device according to an embodiment.

FIG. 2 is an exemplary view showing a procedure of a write operation in the embodiment.

FIG. 3 is an exemplary flowchart of a command controller in the embodiment.

FIG. 4 is an exemplary view showing a command/data flow of a case where this embodiment is not applied.

### DETAILED DESCRIPTION

Various embodiments will be described hereinafter with reference to the accompanying drawings. In general, according to one embodiment, a semiconductor storage device comprises processors, a nonvolatile memory with channels, a list storage, and a command generator. The list storage is configured to store an erase address list comprising erase addresses of each of the channels of the nonvolatile memory. The command generator is configured to continuously generate a series of erase commands concerning the erase addresses in the erase address list in response to a single erase request generated from any one of the processors.

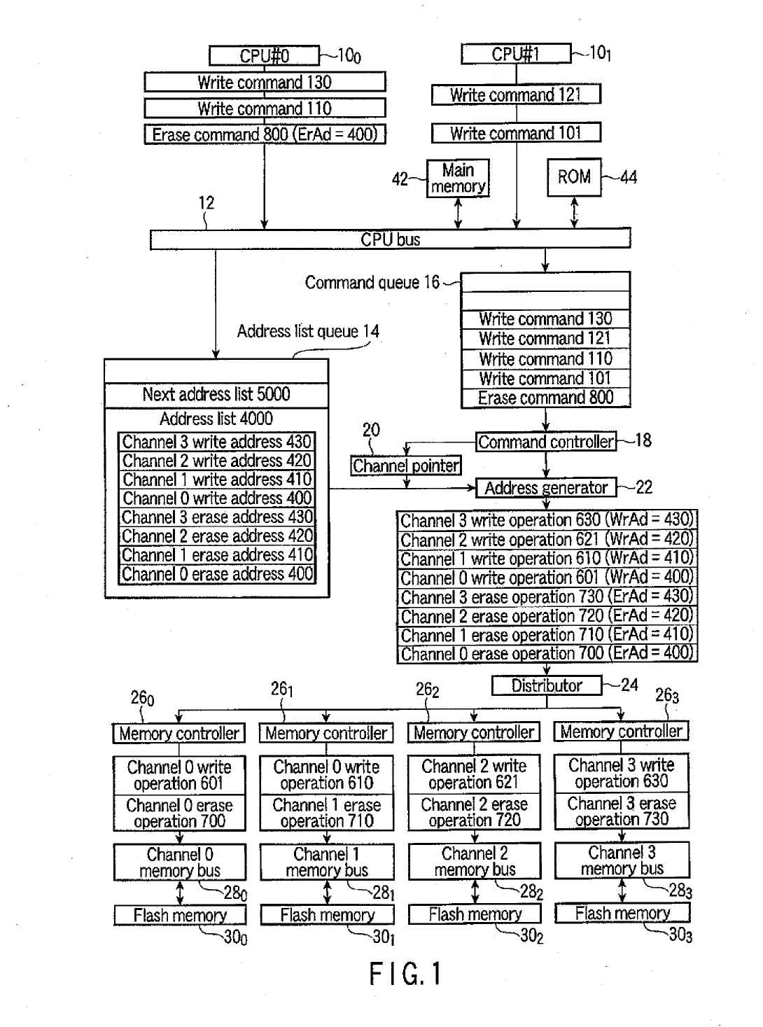

FIG. 1 is a block diagram showing the configuration of an embodiment of a semiconductor storage device together with a command/data flow. This embodiment includes plural nonvolatile memories, for example, four NAND flash memories 30₀, 30₁, 30₂, and 30₃. The NAND flash memories 30₀, 30₁, 30₂, and 30₃ constitute, for example, channels 0, 1, 2, and 3 of a storage section of a solid-state drive (SSD). Although the number of flash memories (channels) is actually greater than the above, only four of them are shown for convenience of explanation. Each of the NAND flash memories 30₀, 30₁, 30₂, and 30₃ is constituted of, for example, two to sixteen memory chips. The NAND flash memories 30₀, 30₁, 30₂, and 30₃ are connected to memory controllers 26₀, 26₁, 26₂, and 26₃ through memory buses 28₀, 28₁, 28₂, and 28₃. The memory controllers 26₀, 26₁, 26₂, and 26₃ are connected to the NAND flash memories 30₀, 30₁, 30₂, and 30₃, and carries out access control.

On the other hand, plural, e.g., two CPUs 10₀ and 10₁ are provided as hosts for convenience' sake. Although each of CPUs 10₀ and 10₁ independently issues an operation request to the flash memories 30₀, 30₁, 30₂, and 30₃, one of the CPUs, here, CPU 10₀ takes charge of memory management. CPUs 10₀ and 10₁ are connected to a common CPU bus 12. A main memory 42, ROM 44, address list queue 14, command queue 16, command controller 18, and address generator 22 are connected to the CPU bus 12. The main memory 42 is constituted of, for example, a DRAM. The ROM 44 includes firmware. The firmware uses CPUs 10₀ and 10₁ to control a read operation, write operation or the like of the NAND flash memories 30₀, 30₁, 30₂, and 30₃ by I/O command access to the inside of the memory controllers 26₀, 26₁, 26₂, and 26₃.

The command queue 16 is a FIFO register configured to capture command issuance requests issued from CPUs 10₀ and 10₁ in the order of issuance, and fetch the requests in the order of capture. The address list queue 14 is a FIFO register configured to capture an address list for erase or address list for write constituted of an address of a flash memory for each channel which is a processing object of a request for each of the requests captured in the command queue 16. The address list is prepared by the firmware. In the address list queue 14, although capture is carried out for each address list, fetch is carried out for each address, and a channel pointer 20 is provided to control the fetch address.

The command controller 18 fetches a command issuance request from the command queue 16, and generates a command used to execute an operation of the request. It should be noted that the command controller 18 switches the fetch order according to whether the request is a write command issuance request or an erase command issuance request and, while the command controller 18 fetches the write command issuance requests one by one, the command controller 18 fetches the erase command issuance requests in such a manner that the same request is repetitively fetched the number of times corresponding to the number of channels of addresses written in the address list.

The address generator 22 adds an address read from the address list queue 14 to a command to realize the command issuance request fetched by the command controller 18, and issues an erase command or a write command. The issued command is supplied to the memory controllers 26₀, 26₁, 26₂, and 26₃ of a predetermined channel through a distributor 24.

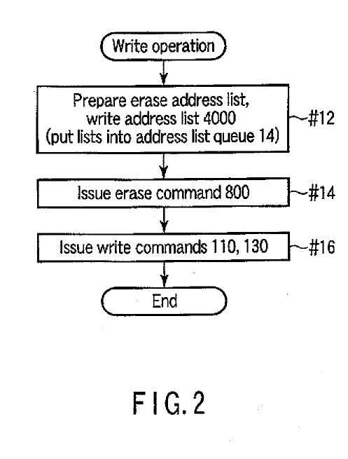

Next, the write processing of the embodiment will be described below. FIG. 2 shows a flow of the processing of the firmware. In order to efficiently use the memory buses of the plurality of channels in parallel, the firmware prepares an address list indicating an address of each channel prior to issuance of a write command. Further, as described above, overwriting cannot be carried out in the flash memory when data is written. Therefore, it is necessary to execute an erase operation in advance for the same address as the address which is an object of write before executing a data write operation. For this reason, before issuing a write request, the firmware prepares an address list 4000 constituted of a write address list indicating an address of each channel of a flash memory to which data is to be written, and erase address list indicating an address of each channel of a flash memory from which data is erased, and puts the address list 4000 into the address list queue 14 (block #12). It should be noted that erase and write are executed at the same address. Therefore, only the write address list may be put into the address list queue 14, and write address list may also be used as an erase address list. The reason for putting both the address lists into the queue 14 is that there are cases where it is appropriate to provide independently both the address lists depending on the requesting order of the write command issuance request and erase command issuance request in the firmware.

Here, the address list 4000 is constituted of a channel 0 write address 400, channel 1 write address 410, channel 2 write address 420, channel 3 write address 430, channel 0 erase address 400, channel 1 erase address 410, channel 2 erase address 420, and channel 3 erase address 430. An erase address is arranged at a tail end of a write address.

Next, as shown in block #14, an erase command issuance request (erase command) 800 is issued from CPU 10₀ in charge of memory management. In the erase command issuance request 800, multiple addresses (channels) or a single address (channel) to be erased may be set. After this, in block #16, a write command issuance request (write command) for each channel is appropriately output from each of CPUs 10₀ and 10₁. In this example, a write command issuance request for each of channels 1 and 3 is output from CPUs 10₀, and write command issuance request for each of channels 0 and 2 is output from CPU 10₁.

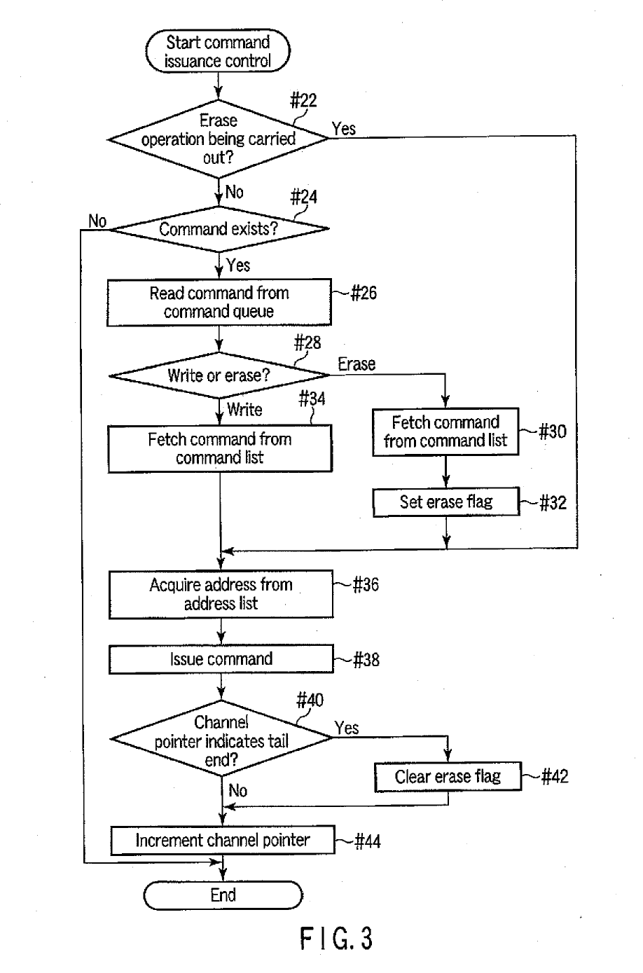

FIG. 3 is a view showing a control flow of the command controller 18. In block #22, the command controller 18 determines whether or not an erase operation is still being carried out. When the erase operation is not being carried out, it is determined in block #24 whether or not a command issuance request exists in the command queue 16. When a command issuance request does not exist therein, the processing is terminated.

When a command issuance request exists in the command queue 16, the command issuance request is read from the command queue 16 in block #26. In block #28, a type (write or erase command) of the read request is determined.

When the request is a write command issuance request, the write command is fetched from a command list in block #34, and the flow is shifted to block #36. When the request is an erase command issuance request, the erase command is fetched from the command list in block #30, an erase flag is set in block #32, and thereafter the flow is shifted to block #36. In the example of FIG. 1, an erase command issuance request 800 is first fetched, and thereafter write command issuance requests 101, 110, 121, and 130 associated with channels 0, 1, 2, and 3 are fetched. The command controller 18 fetches plural erase commands for each channel from the command list for one erase command issuance request 800, whereas the controller 18 fetches a write command of a corresponding channel for each request for a write command issuance request.

In block #36, an address is acquired from the address list queue 14 and, in block #38, the address is added to the command, and an actual operation command (write operation, erase operation) is issued. The channel pointer 20 configured to scan the address list 4000 is incremented each time an operation command is issued.

After the issuance of the operation command, it is determined in block #40 whether or not the channel pointer 20 indicates a tail end of the queue 16. When the tail end thereof is not indicated, the flow is shifted to block #44 as it is, and when the tail end is indicated, the flow is shifted to block #44 after the erase flag is cleared in block #42. In block #44, the channel pointer 20 is incremented.

As described above, erase operation commands 700, 710, 720, and 730 are issued by the addition of the channel pointer 20 configured to scan the address list queue 14 on the basis of the type (write request, erase request) of the command issuance request received from the command queue 16, and by switching of the order of the extraction from the command queue 16. The multiple erase operation commands 700, 710, 720, and 730 are successively generated from the single erase command issuance request 800. Therefore, an erase operation of plural pages associated with one write operation is continuously executed without being interrupted by other operations (for example, a write operation) midway through the operation. As a result of this, it becomes possible to continuously execute the erase operations 700 to 730 with respect to the channels included in the address list 4000 by the minimum (one time) output of the erase command issuance request as shown in FIG. 2, and improve the efficiency in executing erase operations in parallel.

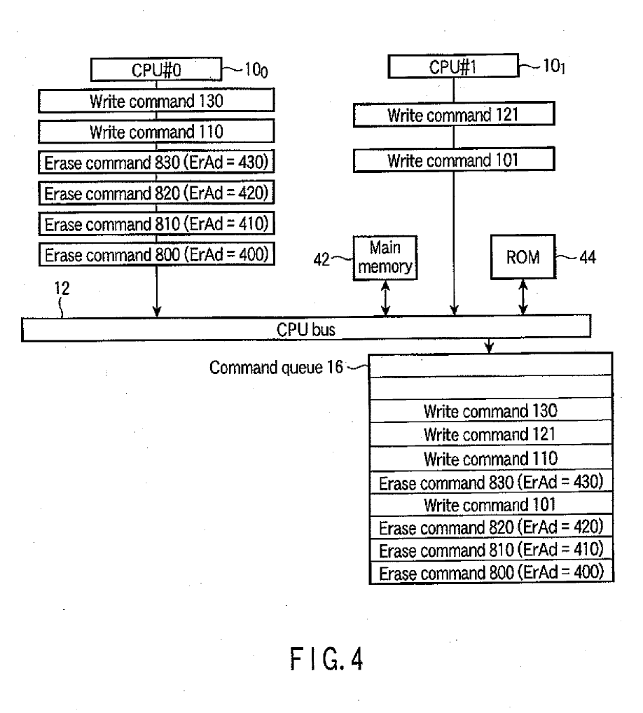

When this embodiment is not employed, the firmware causes CPU 10₀ to generate plural erase command issuance requests 800, 810, 820, and 830 for each channel as shown in FIG. 4. Therefore, there is the possibility of a request (write command issuance request 101 in FIG. 4) from CPU 10₁ other than CPU 10₀ being generated during the period. In this case, the erase command issuance requests 800, 810, 820, and 830, write command issuance request 101, erase command issuance request 830, write command issuance request 110, . . . are stored in the command queue 16. Therefore, there is the possibility of other command issuance requests being wedged into the series of erase command issuance requests. In this embodiment, only a single erase command issuance request is generated from CPU 10₀. Therefore, there is no possibility of other requests being wedged into the series of erase requests.

It should be noted that the present invention is not limited to the above-mentioned embodiment as it is. For example, although the write address list and erase address list are independently stored in the address list queue 14, both the lists indicate the same address. Therefore, the same address list may be used in common for both the purposes of write and erase. In this case, in the address list queue 14, only the write address list is stored. Further, even when both the lists are stored therein, the firmware may not prepare both the lists, and the erase address list may be automatically added to the tail end of the write address list queue.

According to an embodiment, when a single erase operation request from one CPU is generated, plural erase operations for plural channels described in an erase address list are continuously carried out without interruptions caused by other operations. As a result of this, there is no need of arbitrating the semaphore in consideration of exclusive control between the plurality of CPUs, or fetching an erase command over the head of an interrupt command by changing the order when a command is to be fetched from the command queue, and it is possible to carry out plural erase operations by simple control and at low cost. Accordingly, in a semiconductor storage device configured to distribute erase requests to nonvolatile memories of plural channels, and execute erase operations in parallel, there is no need of taking exclusive control between plural CPUs into consideration, and it is possible to carry out erase operations of nonvolatile memories of plural channels in parallel by simple control without interruptions caused by other operations.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor storage device comprising:
a plurality of processors;
a nonvolatile memory comprising a plurality of channels;
a list storage configured to store an erase address list, the erase address list comprising an erase address for each of the channels of the nonvolatile memory; and
a command generator configured to generate a series of contiguous erase commands for the erase addresses in the erase address list in response to a single erase request generated by any one of the processors.

2. The device of claim 1, further comprising:
a distributor configured to supply each erase command in the series of erase commands to a respective channel of the nonvolatile memory in accordance with the erase addresses.

3. The device of claim 1, wherein the nonvolatile memory comprises a memory that requires execution of an erase operation prior to execution of a write operation.

4. The device of claim 1, wherein the erase address list is identical to a write address list comprising write addresses for each of the channels of the nonvolatile memory.

5. A method of controlling a semiconductor storage device comprising a plurality of processors and a nonvolatile memory comprising a plurality of channels, the method comprising:
preparing an erase address list comprising an erase address for each of the channels of the nonvolatile memory; and
generating a series of contiguous erase commands for the erase addresses in the erase address list in response to a single erase request generated by any one of the processors.

6. The method of claim 5, further comprising:
supplying each erase command in the series of erase commands to a respective channel of the nonvolatile memory in accordance with the erase addresses.

7. The method of claim 5, wherein the nonvolatile memory comprises a memory that requires execution of an erase operation prior to execution of a write operation.

8. The method of claim 5, wherein the erase address list is identical to a write address list comprising write addresses for each of the channels of the nonvolatile memory.
